(19) United States
(12) Patent Application Publication
(10) Pub. No.: US 2018/0317713 A1
(43) Pub. Date: Nov. 8, 2018

(54) METHOD FOR OPERATING A FOOD PROCESSOR

(71) Applicant: Vorwerk & Co. Interholding GmbH, Wuppertal (DE)

(72) Inventors: Stefan HILGERS, Essen (DE); Maximilian KOENNINGS, Zuerich (CH); Wenjie YAN, Duesseldorf (DE); Maria RESENDE, Lisboa (PT); Michael SICKERT, Ennepetal (DE)

(73) Assignee: Vorwerk & Co. Interholding GmbH, Wuppertal (DE)

(21) Appl. No.: 15/969,934

(22) Filed: May 3, 2018

(30) Foreign Application Priority Data
May 4, 2017 (DE) 10 2017 109 584.5

(51) Int. Cl. A47J 43/07; A47J 43/046; B01F 13/10; B01F 15/00

(52) U.S. Cl. CPC A47J 43/0716; A47J 43/046; B01F 13/1041; B01F 2215/0026; B01F 15/00538; A47J 2043/0733; B01F 2013/108; B01F 15/00194

(57) ABSTRACT

The invention relates to a method for operating a food processor (1) with a base unit (2) having an electric motor and a preparation vessel (3) that can be arranged on a vessel retainer of the base unit (2), wherein the vessel retainer has allocated to it a weighing apparatus (4), which records the weight of the preparation vessel (3), wherein a calculating means of the food processor (1) determines a weight from a measured value measured by the weighing apparatus (4). In order to advantageously use the weighing apparatus (4) to recognize a current state of the food processor (1), it is proposed that the calculating means ascertain a time weight gradient based on at least two weights determined at different times.

### AREA OF TECHNOLOGY

The invention relates to a method for operating a food processor with a base unit having an electric motor and a preparation vessel that can be arranged on a vessel retainer of the base unit, wherein the vessel retainer has allocated to it a weighing apparatus, which records the weight of the preparation vessel, wherein a calculating means of the food processor determines a weight from a measured value measured by the weighing apparatus.

In addition, the invention relates to an electric motor-operated food processor having a base unit with an electric motor, a calculating means and a preparation vessel that can be arranged on a vessel retainer of the base unit, wherein the vessel retainer has allocated to it a weighing apparatus, which records the weight of the preparation vessel.

### PRIOR ART

Food processors of the aforementioned kind are sufficiently known in prior art. Involved here are food processors for processing foods, which have a weighing apparatus with a force-transducing element that determines the weight of foods located in a preparation vessel. During the weighing process, the preparation vessel is carried by the force-transducing element, which for its part is connected with the base unit. For example, the force-transducing element is a weighing beam, which is arranged between two bearing areas of the base unit that can be displaced relative to each other, and has strain gauges arranged thereon, the signal of which can be evaluated by an electronic circuit. In this way, a preparation item located in the preparation vessel can be weighed.

For example, publication DE 10 2009 059 242 A1 discloses a food processor with a weighing apparatus having a weighing beam, which is fastened to parts of a device that can move relative to each other and has one or more notches between the fastening areas. Arranged on the upper side of the beam is a strain gauge, which during exposure to weight is subject to local expansions of the material, which cause its measuring resistance to change. The change in resistance of the strain gauge is thus a measure for the weight of a preparation item located in the preparation vessel.

### SUMMARY OF THE INVENTION

Proceeding from the aforementioned prior art, the object of the invention is to advantageously further develop a food processor of the aforementioned kind and a method for its operation, in particular in such a way that the weighing apparatus can also be used to determine states of the food processor.

To achieve the above object, the invention proposes a method in which the calculating means of the food processor determines a time weight gradient based upon at least two weights determined at different times.

According to the invention, the method thus involves not just determining the weight of a preparation item located in the preparation vessel, but rather also determining a time weight gradient, i.e., a change in a measured weight over a specific timespan. The weight gradient is a measure for how fast and by what value a measured value changes. This determined time weight gradient can then in turn be used to measure abnormal states of the food processor that do not correspond to a usual addition of preparation items into the preparation vessel or a usual removal of preparation items from the preparation vessel.

In particular, it is proposed that the calculating means compare the weight gradient with a defined reference gradient, which characterizes a time-dependent weight reduction caused by lifting the food processor from a placement area. Lifting the food processor from a placement area leads to a time weight gradient, which clearly differs from a weight gradient while filling a preparation item into the preparation vessel or removing a preparation item from the preparation vessel. Lifting the food processor from a placement area relieves the weighing apparatus, so that a determined weight changes with a negative gradient that is less than a correspondingly defined reference gradient. The reference gradient clearly drops below a time-dependent weight reduction caused by removing preparation items from the preparation vessel and/or separating the preparation vessel from the food processor. The weight gradients while lifting the food processor from a placement area and while removing preparation items from the preparation vessel or separating the preparation vessel from the food processor are all negative, so that within the meaning of the invention, a smaller weight gradient implies a stronger reduction in weight. The reference gradient here defines which weight reduction can still be regarded as being associated with a conventional operation of the food processor. Given an excessive deviation from the reference gradient, in particular a drop below the latter, it can be inferred that the food processor has been lifted from a placement area.

In this conjunction, it is proposed in particular that the reference gradient be smaller than the weight gradient that arises while separating the preparation vessel from the base unit. The initial weight drawn upon for determining the reference gradient can either be an empty weight of the preparation vessel or an overall weight of the preparation vessel plus whatever preparation items might be contained therein. During operation of the food processor, for example while processing several sequential recipe steps, the reference gradient can thus especially preferably be continuously recalculated. The reference gradient defined in this way can then be compared with a currently determined weight gradient so as to determine a state of the food processor that does not correspond to a usual process, such as filling or emptying the preparation vessel during operation of the food processor.

If the determined weight gradient drops below the reference gradient, the method here provides that a lifting of the food processor be inferred. Since the weight gradient when lifting the food processor along with the previously defined reference gradient are both negative, a dropping below means that the amount of the currently determined weight gradient is greater than the amount of the reference gradient. When the food processor is lifted, the measured weight thus decreases to a greater extent than in the defined reference situation, for example during a separation of the preparation vessel from the base unit.

It is proposed that the weight gradients be determined using measured values whose measuring times are spaced at most 0.5 seconds apart. When measuring the times at which a respective current weight is determined, a shortest timespan within which weight changes usually occur is to be selected, with the latter being caused by the addition or removal of preparation items, a separation of the preparation vessel from the food processor, or also a lifting of the food processor from a placement area. When adding foods into the preparation vessel, the weight usually does not change suddenly, since the preparation item is rather usually added to the preparation vessel slowly, for example to prevent any preparation items from spurting out. The same likewise holds true when removing preparation items from a preparation vessel still arranged inside of the food processor. This is in contrast with a rather abrupt lifting of the preparation vessel from the food processor or a lifting of the food processor from a placement area. As a consequence, the cause of a measured change in weight can be recognized by selecting sequential measuring times spaced less apart by comparison to a timespan involving more of a gradual reduction in weight via the removal of preparation items from the preparation vessel. Proposed in particular are measuring points spaced apart by at most 0.5 seconds, wherein smaller intervals can also be selected, for example intervals of 0.4 seconds, 0.3 seconds, 0.2 seconds, 0.1 second or even smaller intervals. This makes it possible to distinguish between sudden changes in weight and constant changes in weight. In addition, the amount of weight reduction can be used to distinguish between a separation of the preparation vessel from the food processor and a lifting of the food processor, which both trigger sudden changes in weight, since the preparation vessel, whether filled or unfilled, is usually lighter than the food processor. As a consequence, the negative weight gradient while lifting the food processor from a placement area is in both instances usually still smaller than the weight gradient while removing the preparation vessel from the food processor. This corresponds to a quantitatively larger weight gradient when lifting the food processor as opposed to a weight gradient when separating the preparation vessel from the food processor.

It can further be provided that at least two other weight gradients be determined spaced apart in time if a value drops below the reference gradient. In particular, a time interval of at least 0.5 seconds is proposed for this purpose. Larger time intervals are also recommended, for example time intervals of 1 second, 2 seconds, 3 seconds or more. By proceeding in this way, additional weight gradients are calculated in a chronological sequence once a lifting of the food processor from a placement area has been determined. As a result, additional states of the food processor can advantageously be detected. A currently calculated weight gradient that drops below a reference gradient can here initiate the calculation of additional weight gradients at a later time. As a result, another weight progression is specifically observed after a lifting of the food processor from a placement area had previously been detected. This measure enables a determination of whether the electric motor of the food processor is currently turned on or off. This is made possible by the fact that an operational motor transmits vibrations, and hence forces, to the housing of the food processor, which also act on the weighing apparatus. The overall forces acting on the weighing apparatus with the electric motor turned off thus differ from the forces acting with the electric motor turned on.

In order to recognize the operating status of the electric motor, it is proposed that a non-operating electric motor be inferred upon determining chronologically sequential weight gradients within the range of a value for a weight gradient characterizing a lifting of the food processor, in particular given essentially constant sequential measured values. In this embodiment, a value dropping below the reference gradient is followed by an essentially constant measuring signal. Plotted on a resistance-time diagram, this initially corresponds to a strong drop in weight with a subsequent signal plateau, for example. If such a measured value progression is found, a non-operating electric motor can be inferred. The further progression over time of the measured value—even after the value has dropped below the reference gradient—can thus be used to detect states of the food processor which can advantageously be drawn upon for the further control of the food processor. As a consequence, a non-operating electric motor yields a characteristic chronological sequence for the measured value, wherein a measured resistance (or tension) initially remains constant until the food processor is lifted from a placement area, for example, and then abruptly drops to a minimum at which the measured value then essentially remains. Knowledge about the electric motor being turned off can subsequently in turn be used for other measures. This will be further explained below.

In addition, it is initially analogously proposed that an operating electric motor be inferred upon determining chronologically sequential weight gradients within the range of a value for a weight gradient ascertained before a drop below the reference gradient. During electric motor operation, lifting the food processor from a placement area initially also leads to a value dropping below the reference gradient, wherein a rise in the weight gradient to the previously ascertained level then takes place again owing to vibrations of the activated electric motor, however. Therefore, lifting the food processor only causes a brief lowering of the measured value, i.e., without the measured value remaining at a plateau characterizing a minimum. As a result, the further chronological sequence of the weight after lifting the food processor can be used to determine whether the electric motor is operating or not.

Depending on the above, it is further proposed that the user be given the option of turning on a transport mode and/or turning off the food processor if a non-operating electric motor is detected, and/or that the user be given the option of turning off the electric motor if an operating electric motor is detected. During a continuous operation of the electric motor, this makes it possible to turn off the electric motor directly, i.e., for example with only single keystroke, so as to avoid undesired operating states. If the electric motor has not been turned on, a user can just as easily initiate a transport mode, for example by confirming an action proposed on the food processor display, whereupon the food processor turns itself off. As a result, the transport mode need no longer be activated via a detailed menu navigation of the food processor. In like manner, the food processor can be completely shut down. As a whole, then, when the food processor is lifted, an active electric motor can be turned off, or a transport safeguard can be initiated or the food processor turned off given a deactivated electric motor.

The method according to the invention can be implemented using the software of the food processor, wherein the calculating means described above determines and further processes the weight gradients. No additional components are needed for the food processor.

Finally, in addition to the method described above, the invention also proposes an electric motor-operated food processor, which has a base unit with an electric motor, a calculating means and a preparation vessel that can be arranged on a vessel retainer of the base unit, wherein the vessel retainer has allocated to it a weighing apparatus, which records the weight of the preparation vessel, wherein the calculating means is designed and set up to implement a previously described method.

As explained above, the electric motor-operated food processor according to the invention differs from electric motor-operated food processors known in prior art by the calculating means, which now is designed and set up according to the invention to calculate a time weight gradient from at least two measured values determined at different times. The other features of the calculating means are here as described before in relation to the method. In particular, the calculating means can be designed and set up to compare the weight gradient with a defined reference gradient, which characterizes a time-dependent weight reduction when lifting the food processor from a placement area.

### BRIEF DESCRIPTION OF THE DRAWINGS

The invention will be explained in more detail below based upon exemplary embodiments. Shown on:

FIG. 1 is perspective view of a food processor according to the invention,

FIG. 2 is a partially cut, side view of the food processor,

FIG. 3 is a magnified cutout of the food processor according to FIG. 2,

FIG. 4 is the cutout of the food processor depicted on FIG. 3 while lifting the food processor from a placement area,

FIG. 5 is a resistance-time diagram while lifting the food processor with the electric motor turned on,

FIG. 6 is a resistance-time diagram while lifting the food processor with the electric motor turned off,

FIG. 7 is a flowchart of a method according to the invention for operating the food processor.

### DESCRIPTION OF THE EMBODIMENTS

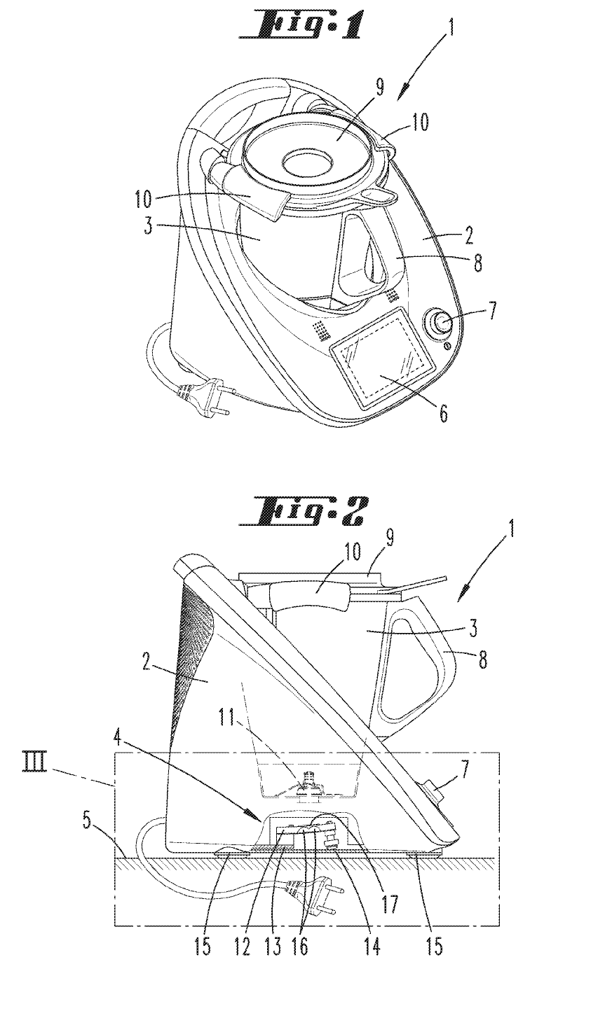

FIG. 1 shows an electric motor-operated food processor 1, which is here designed as a combined cooker-mixer. The food processor 1 has a base unit 2, with which a preparation vessel 3 is connected. The preparation vessel 3 has allocated to it a heater (not shown), here preferably integrated into the vessel floor of the preparation vessel 3. Also arranged inside the preparation vessel 3 is an agitator 11, which can be used to comminute, mix and/or otherwise prepare the preparation items present in the preparation vessel 3. The preparation vessel 3 further has allocated to it a cover 9, which can be fixedly joined with the preparation vessel 3 by means of locking elements 10. In addition, the preparation vessel 3 has a handle 8 with which a user grips the preparation vessel 3. The base unit 2 further has a display 6 for displaying status parameters of the food processor 1, suggested recipes, current parameters of the preparation item located in the preparation vessel 3, and the like. A switch 7, for example here designed as a rotary push knob, serves to activate and deactivate an electric motor (not shown) of the food processor 1 and/or the food processor 1 as a whole. In addition, the switch 7 can be used to select and confirm a command or parameter indicated on the display 6.

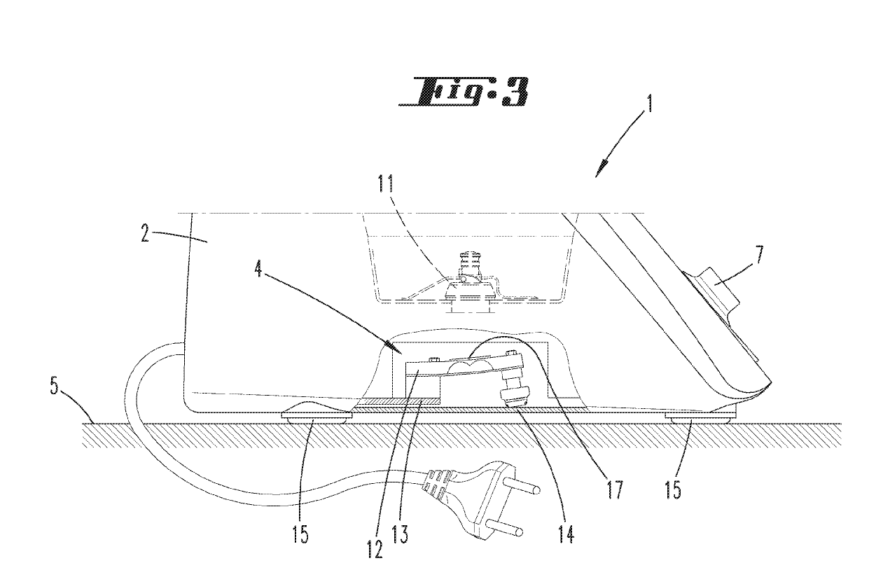

FIG. 2 shows the food processor 1 with the preparation vessel 3 in a partially broken side view. The food processor 1 stands with its feet 15 on a placement area 5, for example a kitchen countertop. Evident on this figure is the agitator 11, which here is designed as a blade assembly with a plurality of blades. The agitator 11 rotates around a rotational axis, which simultaneously is a longitudinal axis of the preparation vessel 3. Arranged in the base unit 2 of the food processor 1 below the preparation vessel 3 is a weighing apparatus 4, which is mounted on bearing areas 13, 14 of the food processor that can be displaced relative to each other. The weighing apparatus 4 has a weighing beam 12 with two notches 16 running parallel to each other. The notches 16 yield materially weakened areas of the weighing beam 12, which allow an expansion or compression of the weighing beam 12. The weighing apparatus 4 or bearing areas 13, 14 are loaded with the weight of the preparation vessel arranged above them, so that the weighing beam 12 expands or compresses given a change in weight, e.g., as the result of filling preparation items. A strain gauge 17 is arranged on the upper side of the weighing beam 12 facing away from the notches 16, and its resistance changes given an expansion or compression of the weighing beam 12, and hence also of the strain gauge 17. This resistance can be further processed by a calculating means of the food processor 1 and converted into a weight. Publication DE 10 2009 059 242 A1 provides a detailed description of detecting the tensile and compressive stresses by means of the strain gauge. The function of the weighing apparatus disclosed therein, including various embodiments, correspondingly applies to the described food processor 1 here as well.

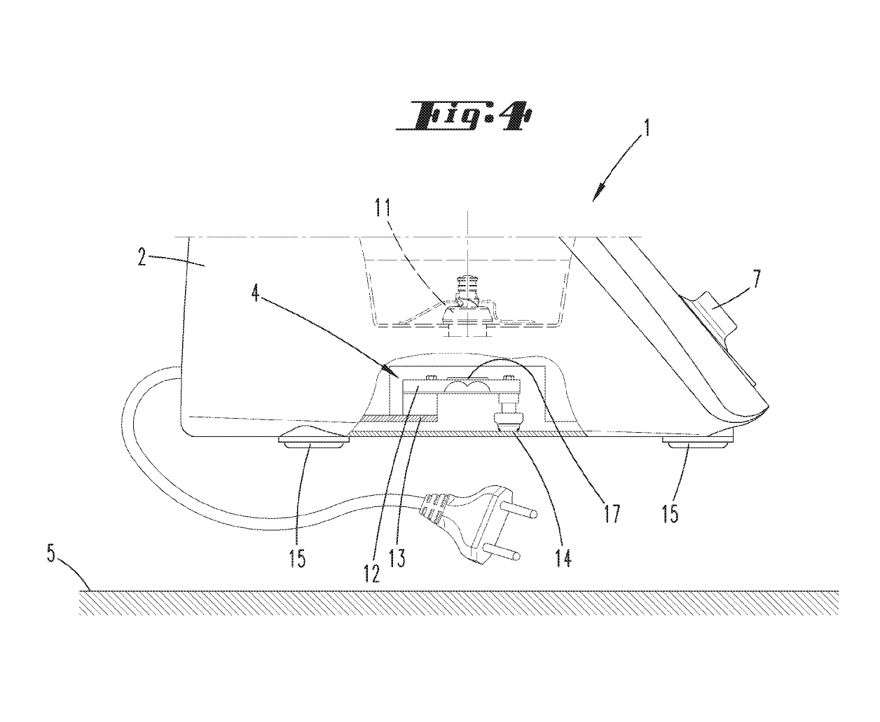

FIG. 3 shows a magnified partial area of the food processor 1 below the preparation vessel 3. In the depicted state of the food processor 1 standing on the placement area 5, the weighing apparatus 4, in particular the weighing beam 12, has a shape and position exaggeratedly shown for clarification purposes. The food processor 1 stands with its feet 15 on the placement area 5. As a result, the bearing area 14 present on the housing of the food processor 1 is preloaded, and presses an end area of the weighing beam 12 toward the top, i.e., in the direction of the preparation vessel 3. The preload on the weighing beam 12 simultaneously leads to a deformation of the strain gauge 17. The deformation of the strain gauge 17 in turn leads to a change in resistance, which can be evaluated by way of the calculating means of the food processor 1. The resistance of the strain gauge 17 characterizes the contact between the food processor 1 and placement area 5, along with the current weight of the preparation vessel 3 and any preparation items that might be located therein. With the food processor 1 standing on the placement area 5, a preparation item located inside of the preparation vessel 3 can thus be weighed in the usual manner.

In addition, the weighing apparatus 4 can also be used to determine a lifting of the food processor 1 from the placement area 5. This lifting is depicted on FIG. 4. The lifting of the feet 15 of the food processor 1 from the placement area 5 causes a displacement of the bearing area 14 relative to the bearing area 13 of the food processor 1. The weighing beams 12 and strain gauge 17 arranged thereon correspondingly deform. This deformation is exaggeratedly illustrated on FIG. 4, so as to explain the principle. It here goes without saying that the bends in the weighing beam 12 shown on FIGS. 3 and 4 are only exemplary in nature. Of course, it is also possible for the weighing beam 12 to not be bent in a state of the food processor 1 standing on the placement area 5, while the weighing beam 12 does bend when lifting the food processor 1 from the placement area 5.

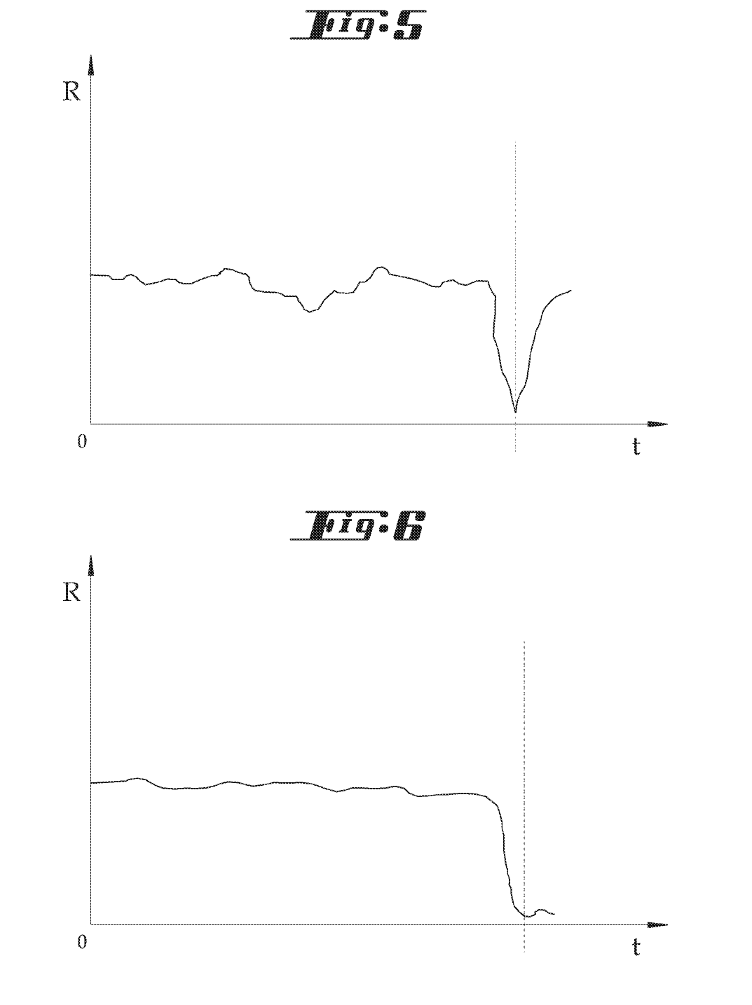

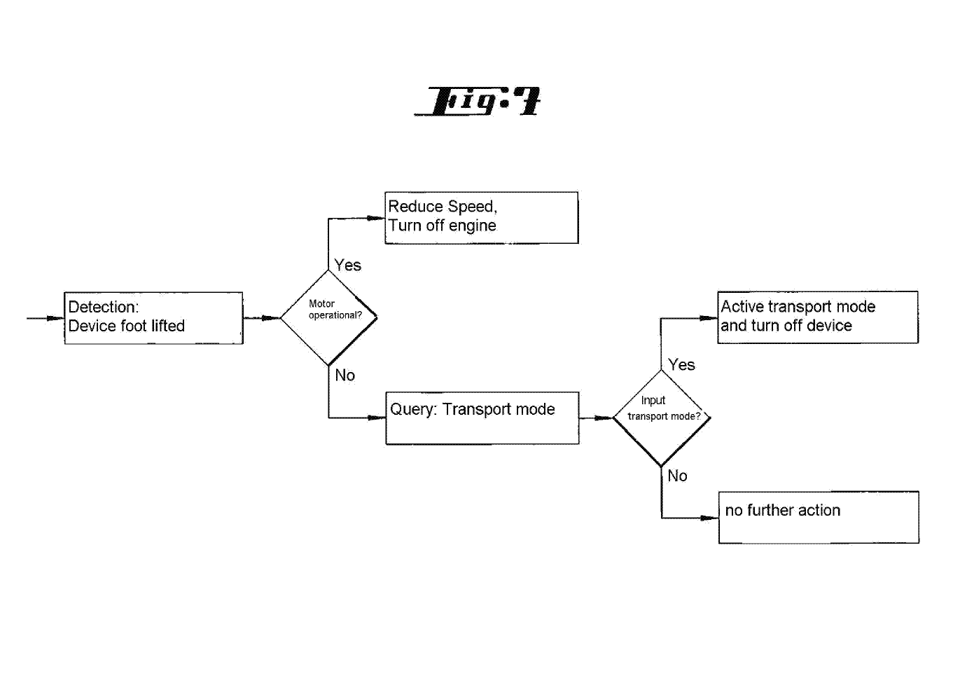

The weighing apparatus 4 of the food processor 1 can now be used according to the invention to detect a lifting of the food processor 1 from the placement area 5. To this end, the calculating means of the food processor 1 ascertains a time weight gradient out of at least two weight values determined at different times and the respective time difference. The weight gradient is defined as a difference in weight per time difference, and corresponds to a (positive or negative) incline on a graph in a resistance-time diagram. The determined weight gradient is then compared with a defined reference gradient, which is known to arise when the food processor 1 is lifted from the placement area 5. This reference gradient is filed in a memory of the food processor 1. The calculating means accesses this memory for comparison purposes. The weight gradient arising while the food processor 1 is lifted from the placement area 5 is negative, i.e., corresponds to a negative incline of a graph in the resistance-time diagram (R-t diagram). Such a diagram is presented on FIGS. 5 and 6 for various operating states of the food processor 1, specifically on FIG. 5 for a food processor 1 with activated electric motor at the time the food processor 1 is lifted from the placement area 5 (dashed, perpendicular line) and on FIG. 6 for a food processor with deactivated electric motor while lifting the food processor 1 (dashed, perpendicular line).

During operation of the food processor 1, weight gradients are determined from two chronologically sequential measured values at specific time intervals, for example every 0.2 seconds, wherein the calculated weight gradients are each compared with the reference gradient. If a calculated (negative) weight gradient is lower than the previously defined (also negative) reference gradient, a lifting of the food processor 1 is inferred. In the diagrams shown on FIGS. 5 and 6, such a weight gradient that characterizes a lifting of the food processor corresponds to a sudden, major drop in the graph, which is steeper than a drop given a separation of the preparation vessel 3 from the base unit 2, for example.

Once a lifting of the food processor 1 has been detected, it can further be determined whether the electric motor is operating or not at the time the food processor 1 was lifted. Depending thereupon, additional measures can be provided for the food processor 1. To this end, additional weight gradients are calculated even after a lifting of the food processor 1 has been detected, wherein measured values are for this purpose measured at time intervals measuring at least 0.5 seconds. Continuing the measurements makes it possible to determine how the weight gradients will develop further after the lifting of the food processor 1. As a result, an operating state of the electric motor of the food processor 1 can be detected, since the electric motor transmits vibrations to the food processor 1 during operation, which also act on the weighing apparatus 4. For this reason, the weight gradients differ from each other while the electric motor is operating and the electric motor is not operating.

As depicted on FIG. 5, when the electric motor of the food processor 1 is running, lifting the food processor 1 initially leads to a short-term drop in the resistance R measured by the strain gauge 17, wherein the resistance R subsequently rises again to a range that roughly corresponds to the value prior to lifting the food processor 1. By contrast, if the electric motor is not operating when the food processor 1 is lifted, as shown on FIG. 6, the drop in resistance R is not followed by a renewed rise. Rather, a resistance plateau comes about after the time that the food processor 1 was lifted. As a consequence, the progression of the weight gradient over time t can be used to determine whether the electric motor of the food processor 1 is currently running or not. The behavior of the food processor 1 can be further controlled based upon this information.

FIG. 7 presents a flowchart for the method of operating the food processor 1 upon detection of a lifting of the food processor 1 from the placement area 5. If it was detected that the electric motor of the food processor 1 is operating, a controller of the food processor 1 can automatically reduce the speed of the electric motor or even turn off the electric motor. If necessary, the display 6 to this end provides a user of the food processor 1 with an option that he or she can select and/or confirm to turn off the electric motor. In the event that the electric motor is already turned off while lifting the food processor 1, an option to turn on a transport mode of the food processor 1 and/or an option to completely turn off the food processor 1 can be displayed to the user. For example, the transport mode can involve locking the preparation vessel 3 with the cover 9, so that the food processor 1 can be transported without separating the preparation vessel 3 and/or the cover 9 from the food processor 1. If desired, the user can also activate the transport mode and turn off the food processor 1 via the display 6. Alternatively, however, he or she can also decide not to initiate any further actions for the food processor 1, so that the food processor 1 stays on, but the electric motor remains turned off.

### REFERENCE LIST

1 Food processor
2 Base unit
3 Preparation vessel
4 Weighing apparatus
5 Placement area
6 Display
7 Switch
8 Handle
9 Cover
10 Locking element
11 Agitator
12 Weighing beam
13 Bearing area
14 Bearing area
15 Foot
16 Notch
17 Strain gauge
R Resistance
t Time

1. A method for operating a food processor (1) with a base unit (2) having an electric motor and a preparation vessel (3) that can be arranged on a vessel retainer of the base unit (2), wherein the vessel retainer has allocated to it a weighing apparatus (4), which records the weight of the preparation vessel (3), wherein a calculating means of the food processor (1) determines a weight from a measured value measured by the weighing apparatus (4), wherein the calculating means ascertains a time weight gradient based on at least two weights determined at different times.

2. The method according to claim 1, wherein the calculating means compares the weight gradient with a defined reference gradient, which characterizes a time-dependent weight reduction caused by lifting the food processor (1) from a placement area (5).

3. The method according to claim 2, wherein the reference gradient is smaller than the weight gradient that arises while separating the preparation vessel (3) from the base unit (2).

4. The method according to claim 2, wherein if the determined weight gradient drops below the reference gradient, a lifting of the food processor (1) is inferred.

5. The method according to claim 1, wherein weight gradients are determined using measured values whose measuring points are spaced at most 0.5 seconds apart.

6. The method according to claim 2, wherein at least two other weight gradients are determined spaced apart in time if a value drops below the reference gradient, in particular at a time interval of at least 0.5 seconds.

7. The method according to claim 6, wherein a non-operating electric motor is inferred upon chronologically sequentially determining a weight gradient within the range of the reference gradient, in particular given chronologically essentially constant sequential measuring signals.

8. The method according to claim 6, wherein an operating electric motor is inferred upon determining chronologically sequential weight gradients within the range of the weight gradient ascertained before a drop below the reference gradient.

9. The method according to claim 7, wherein the user is given the option of turning on a transport mode and/or turning off the food processor (1) if a non-operating electric motor is detected, and/or wherein the user is given the option of turning off the electric motor if an operating electric motor is detected.

10. An electric motor-operated food processor (1) with a base unit (2) having an electric motor, a calculating means and a preparation vessel (3) that can be arranged on a vessel retainer of the base unit (2), wherein the vessel retainer has allocated to it a weighing apparatus (4), which records the weight of the preparation vessel (3), wherein the calculating means is designed and set up to implement a method according to claim 1.
